(19) United States
(12) Patent Application Publication
(10) Pub. No.: US 2007/0171631 A1
(43) Pub. Date: Jul. 26, 2007

(54) LED cove lighting for exterior fascia

(75) Inventor: Gerald Bruce Davis, Houston, TX (US)

Correspondence Address: LSI Graphic Solutions plus, Suite 120, 14902 Sommermeyer Street, Houston, TX, 77041, US

(73) Assignee: LSI Graphic Solutions plus, Houston, TX (US)

(21) Appl. No.: 11/403,616

(22) Filed: Apr. 13, 2006

Related U.S. Application Data
(60) Provisional application No. 60/761,943, filed on Jan. 25, 2006.

(51) Int. Cl. F21S 8/00

(52) U.S. Cl. 362/147; 362/294

(57) ABSTRACT

This invention is a lighting fixture to project even illumination onto flat panels. The fixture is a formed specular aluminum reflector with LEDs mounted to provide even and directed light, with modular connectors and power sources, allowing for variable lengths when combined with field adjustable housings and supports; or when mounted in a fixed length housing, to allow for linear lighting using any number of selectable lengths. This invention provides a pre-determined and directed light pattern requiring no field adjustment. The use of long life, weather resistant light emitting diodes provides for low maintenance and low energy consumption. The use of specular aluminum allows up to 95% of the light to be reflected to the surface, as well as provides heat sink properties further prolonging the life of the LEDs. By focusing all the available light on the desired area and eliminating stray light, lower wattage LEDs can be used.

### CROSS-REFERENCE TO RELATED APPLICATIONS

This application claims priority from Provisional Patent Application Ser. No. 60/761,943, filed Jan. 25, 2006.

### STATEMENT REGARDING FEDERALLY SPONSORED RESEARCH OR DEVELOPMENT

This invention claims no rights under federally sponsored research or development.

### REFERENCE TO SEQUENCE LISTING, A TABLE OR A COMPUTER PROGRAM LISTING COMPACK DISC APPENDIX BACKGROUND OF THE INVENTION

There is no submission of CD containing sequence listing, table or computer program.

### BACKGROUND OF THE INVENTION

The present invention relates to outdoor lighting fixtures and particularly pertains to a new lighting fixture device to provide wash lighting for a building or canopy fascia and more particularly to a modular lighting device employing light emitting diodes (LED) to evenly project colored light onto fascia panels.

The use of outdoor lighting fixtures is well known in the prior art. Outdoor lighting fixtures in prior art consist of basically familiar, expected and obvious structural configurations, although many designs in the crowded prior art have been developed for the fulfillment of countless objectives and requirements. Known prior art includes U.S. Pat. Nos. 6,984,055, 6,846,092, 6,773,135, 6,942,364, and 6,945,675. While these devices fill their respective objectives and requirements, the aforementioned patents do not disclose an LED lighting fixture for building fascia. Typical fascia lighting has involved linear fluorescent lamps, or multiple light sources with spacing and optics to provide even wash patterns. Disadvantages of such systems are the fixed lengths of linear fluorescent lamps, restricting lengths to multiples of the available lamps, or requiring overlapping of lamps. Other lamp types such as HID or Incandescent produce uneven, cone shaped patterns on the surface due to the beam patterns associated with these of light sources. The useful lifetime of such lamps requires frequent maintenance and results in dark spots and voids from individual lamp failures. The cold weather operation of such lamps is limited, and the light output decrease with lower temperatures. The power requirements for such lamps restrict the use of perimeter lighting in areas of high-energy cost or legal limitations.

Recently, some of these uses have been replaced by LEDs. These solid-state devices have long life times, consume less power and provide colored and directed light for illumination. Existing products are linear LED lights for architectural and cove lighting as manufactured by Next Generation Lighting, Nemalux, Sloan LED, PermLight and TIR Industries, to name a few. Known prior art includes U.S. Pat. Nos. 6,882,111; 6,880,952; 6,969,179 and 6,846,093 In general these are custom fixtures intended for interior applications, for illuminating signs or channel letters, or exterior outline lighting. These products serve a purpose for defining and providing perimeter definition, but do not illuminate wide panels effectively. Some of these products have been adapted for fascia illumination, and involved added optics and on site aiming to produce directed and even illumination. The tubes generally used for such products attenuate the light and trap heat. While these provide workable strategies, it would be an advance in the art if LED illumination could be provided in mounting procedures that were simple, relatively inexpensive, and easy to employ, particularly if the light could be controlled for specific purposes.

### BRIEF SUMMARY OF THE INVENTION

It is, therefore, an object of this invention to overcome the disadvantages of prior art, and to enhance LED light sources and LED and reflector combinations. The general purpose of the present invention, which will be described subsequently in greater detail, is to provide a new lighting fixture consisting of an LED and reflector combination to project even illumination onto flat building panels.

These objects are accomplished, in one aspect of the invention, by the provision of a lamp comprising a formed specular aluminum reflector with LEDs mounted to said reflector with heat sink characteristics, in an arrangement to provide even and directed light, with modular connectors and power sources, said modular arrangement allowing for variable lengths when combined with field adjustable housings and supports.

In an alternate embodiment, there is provided a lamp consisting of a formed specular aluminum reflector with LEDs mounted to said reflector with heat sink characteristics, in an arrangement to provide even and directed illumination, and mounted in a fixed length housing, with self contained power sources, and connectors to allow for linear lighting using any number of selectable lengths.

These embodiments of the invention provide a pre-determined and directed light pattern requiring no field adjustment or aiming. The use of long life weather resistant light emitting diodes provides for low maintenance and low energy consumption. The use of specular aluminum allows for 95% of the light to be reflected to the surface, as well as provides heat sink properties further prolonging the life of the LEDs. By focusing all the available light on the desired area and eliminating stray light, lower wattage LEDs can be used to accomplish the illumination levels desired.

### BRIEF DESCRIPTION OF THE SEVERAL VIEWS OF THE DRAWINGS

FIG. 1 Illustrates a place of business having a canopy fascia with cove lighting.

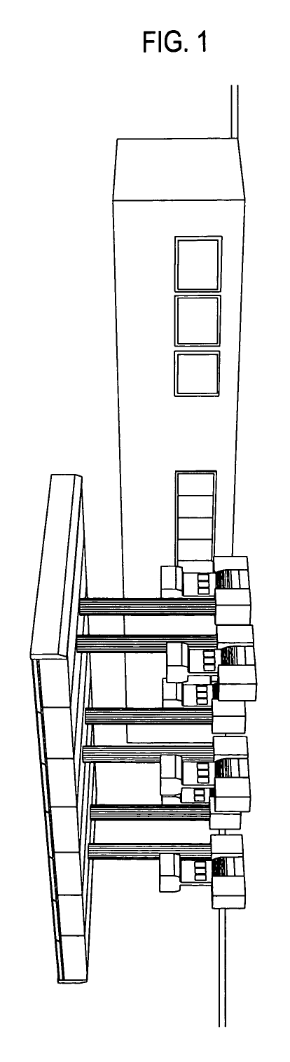

FIG. 2 is a cross sectional view of the present invention mounted to a canopy fascia panel.

FIG. 3 is a cross sectional view with ray tracing of the LED light path through the reflector, illustrating the distribution of lighting.

FIG. 4 is a sectional elevation view with ray tracing of the LED light path, illustrating the overlap of beam angle for even distribution of lighting

FIG. 5 illustrates an embodiment of the invention as a modular LED/reflector assembly

FIG. 6 illustrates an embodiment of the invention as a field cut housing and support brackets

FIG. 7 illustrates an embodiment of the invention as a variable length light fixture

FIG. 8 illustrates the lamp housing as a flat, scored and notched aluminum composite panel

FIG. 9 illustrates the aluminum composite panel folded to form the housing, with overlap and field cutting shown

FIG. 10 illustrates a stamped and formed support bracket and its function as splice between housings

### DETAILED DESCRIPTION OF THE INVENTION

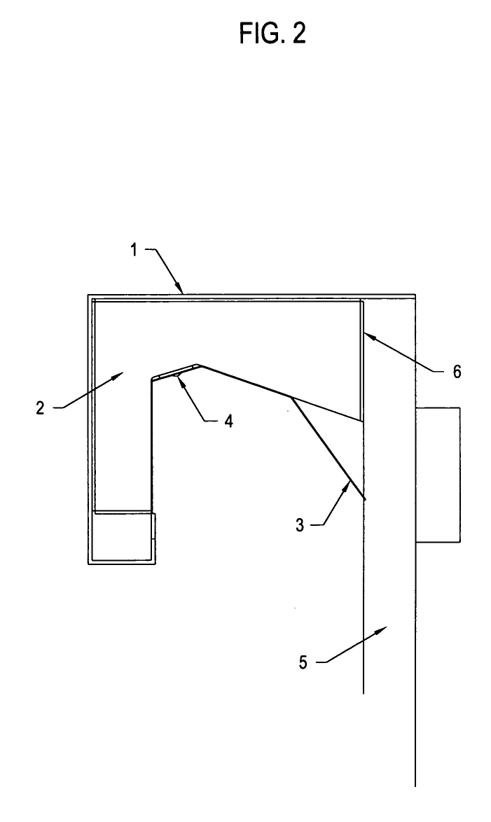

Referring now to the drawings, and specifically FIG. 2, a lighting fixture configured according to a particular embodiment of the present invention is seen, the fixture being mounted to the top edge of a canopy fascia panel 5. The fixture consists of a lamp housing 1 with support brackets and splices 2, with a reflector 3 mounted inside and LEDs 4 mounted to the reflector 3. The support brackets 2 are attached to existing canopy or building fascia panels 5 using hardware (not shown) appropriate to the type of fascia panel 5 on site. The brackets 2 are spaced in multiples of the housing 1 length, such that a bracket 2, falls at the joint of abutting housing panels 1. The folded housing 1 is placed over the top of the fascia panel 5 and attached with self drilling screws 6, and to the support bracket 2 with color matched pop rivets 7. The reflector 3 with LEDs 4 mounted is attached to the support brackets 2 on the tabs provided with pop rivets 8.

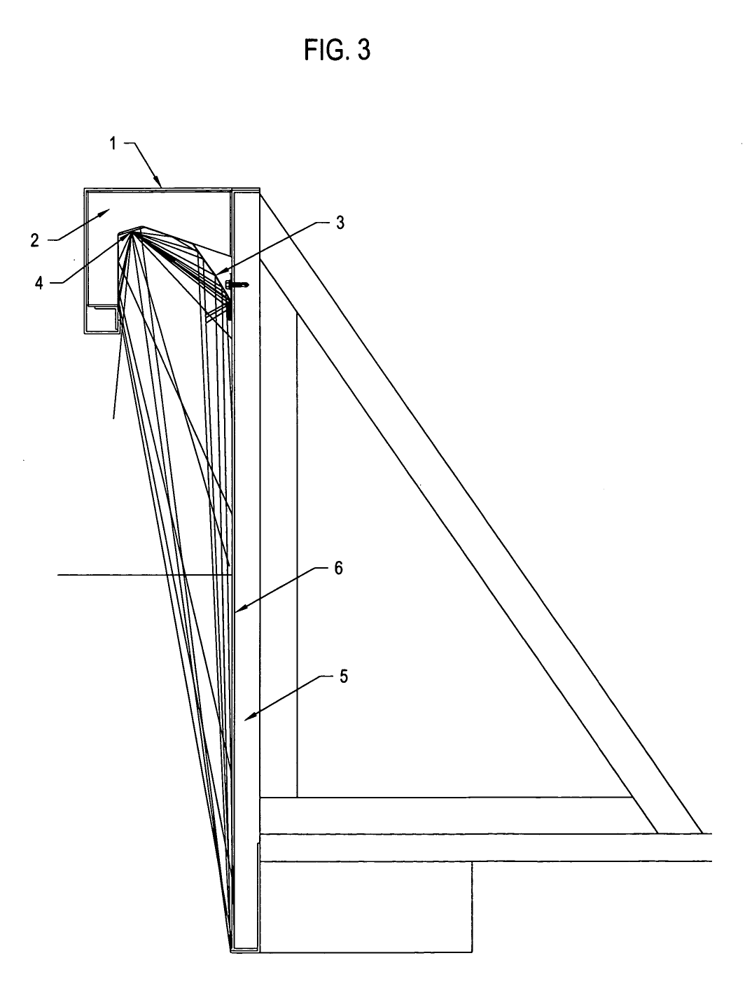

As illustrated in FIG. 3, the reflector 3 is formed with various angles to direct the light from the LEDs 4 in a pattern onto the fascia panel 5 to produce an even gradation. Light is directed to the bottom of the panel 5 to increase the brightness of illumination to more closely match the brightness produced on the upper portion by proximity to the LED 4 source. The shape of the reflector 3 also serves to limit the amount of spill light, and direct the majority of the light onto the fascia panel 5.

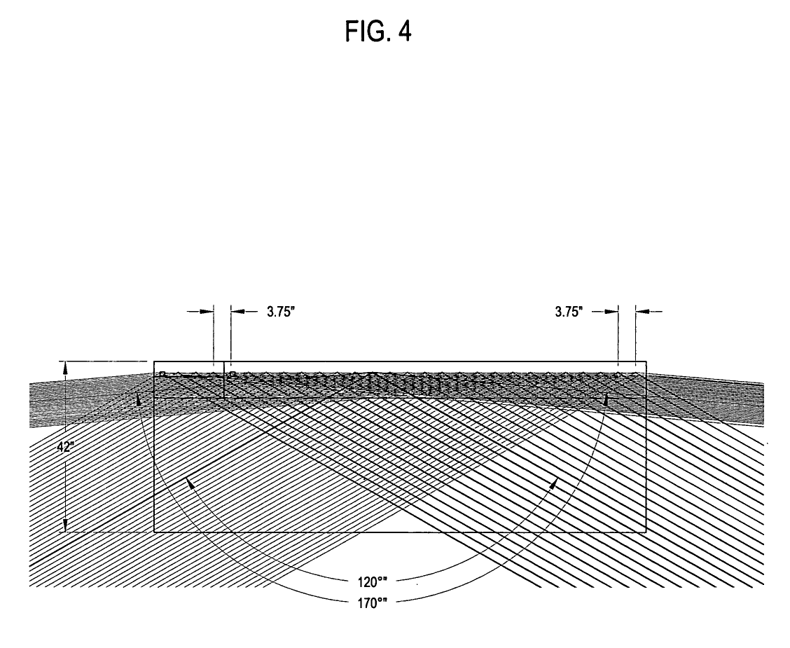

As illustrated in FIG. 4, the spacing of the LEDs 4 in the reflector 3 allows for the beam distribution pattern of the light sources, being 120 to 180 degree spread, to overlap and eliminate any cone shaped patterns in longitudinal light distribution. The spacing of the LEDs 4 determines the length(s) of the reflector 3, being multiples of the spacing, with one half the spacing at the ends so that when two lengths are matched end to end, the spacing is consistent and regular.

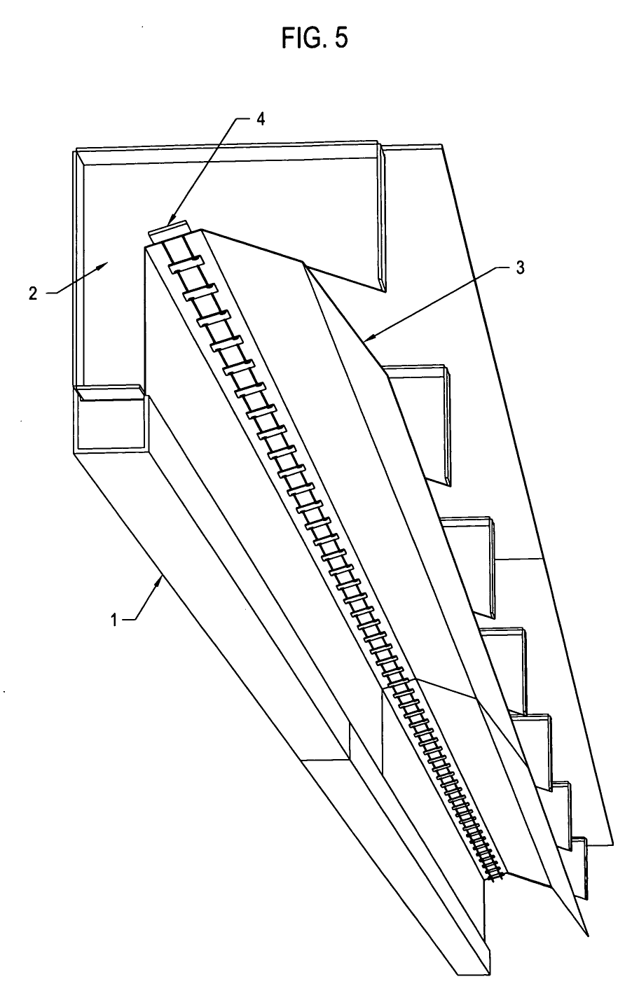

FIG. 5 illustrates one embodiment of the invention, utilizing a formed specular aluminum reflector 3, with LEDs 4 mounted to the surface, and weatherproof snap fit electrical connectors 9 attached to each end. The material used for the reflector 3 preferably is polished anodized aluminum, commonly known as specular aluminum, with reflective properties as high as 95%. This material may also be semi-specular or other reflective material that has the desired reflective, diffusing, and heat sink properties required for a particular LED 4. This material is readily formed by break press with the proper dies and sequence, with mounting and wiring access holes easily punched in the flat before forming. Other methods of manufacture include roll forming and extruding reflector 3 shapes. LEDs 4 of the proper luminous flux, light distribution, and wavelength are attached to the reflector 3 using heat transmissive tape and pop rivets, or other fasteners providing heat transmission such as screws, glues, epoxy, etc. LEDs 4 such as PermLight PZ Series or USLED Pinnacle Series may be used, or other suitable LEDs 4 with properties fitted to a particular fascia panel size and color. A plurality of LEDs 4 are serially connected electrically by wires allowing the correct spacing of modules and assuring the correct polarity. It is understood that in other embodiments, connectors can be provided on the wires to mate with connectors on the LEDs 4 themselves. At the ends of the assembly, the wires are fitted with weatherproof connectors with mating ends to prevent mis-matched polarity. These connections can be used to link several modules together to create continuous linear lighting fixtures. These connections also serve to connect the assemblies to electrical power sources for the LEDs.

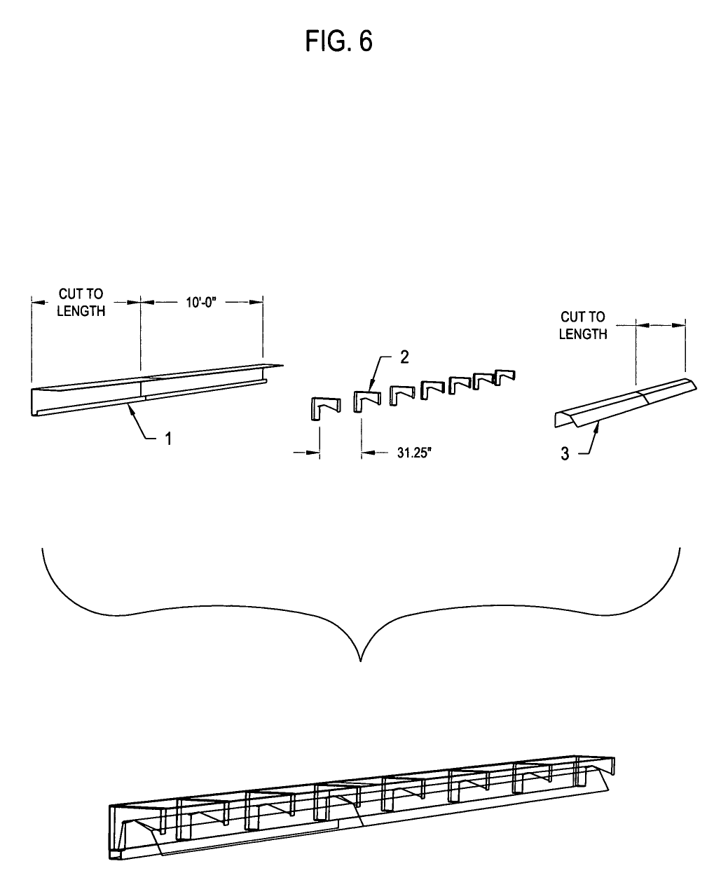

FIG. 6 illustrates a field cut housing 1 and support bracket 2 system for the modular LED/reflector assembly. The support brackets 2 are attached to the fascia panel to be illuminated using suitable fasteners. The LED/reflector assembly is attached to the tabs provided in the support brackets 2, butting end to end to achieve the length required, with snap connectors providing electrical continuity between sections and the introduction of power sources as required, and cutting the last assembly to fit the final length. The housing is then formed and placed over the support brackets, attaching to the fascia panel and the brackets. The support brackets are spaced to also provide a splice or bridging member between sections of the housing, holding these joints in alignment and preventing water intrusion or light escaping. Repeated modules of housings are installed to reach the required length, and the last housing module can be cut to the final length.

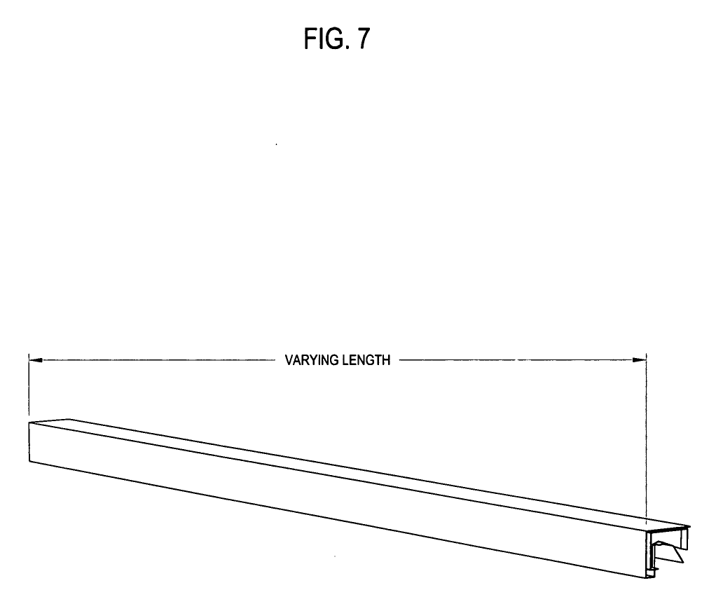

FIG. 7 illustrates yet another embodiment of the invention as a complete light fixture housing, containing the LED/reflector assembly in a fabricated housing of varying length, with supports, wiring and power sources integral to the fixture. Repeated modules of the fixture are installed to reach the desired length, with varying modules available to combine to any multiple of 6″. Custom modules may be produced, or a field adjustable module may be provided.

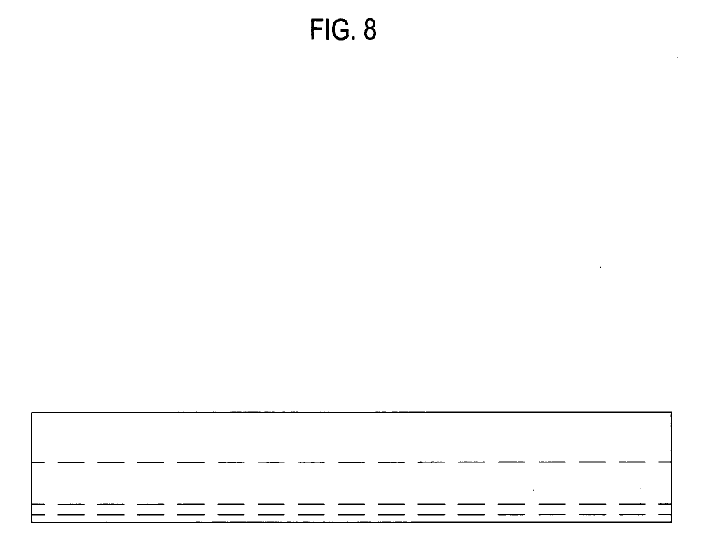

FIG. 8 illustrates the fixture housing as a flat, scored and notched aluminum composite panel. The preferred embodiment would be pre-finished panels of 3 mm thickness, although other materials may be used. These panels are readily produced by using routers or saws to cut V-shaped grooves in the back of the material, allowing panels to ship flat for reduction on freight, and to be simply folded in the field to the final configuration. These panels are easily cut on site to provide custom lengths as required for site conditions.

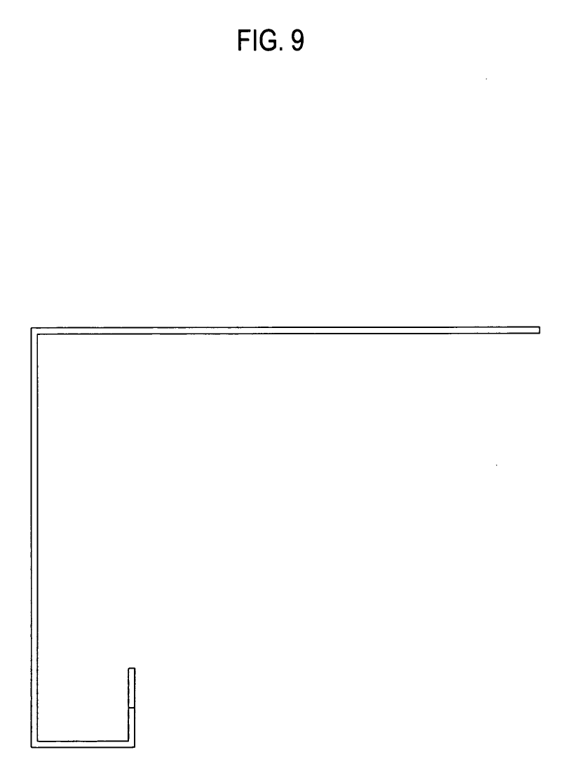

FIG. 9 is an isometric view showing the panel described in FIG. 8 as folded to provide a cove or eyebrow housing for the LED/reflector assembly.

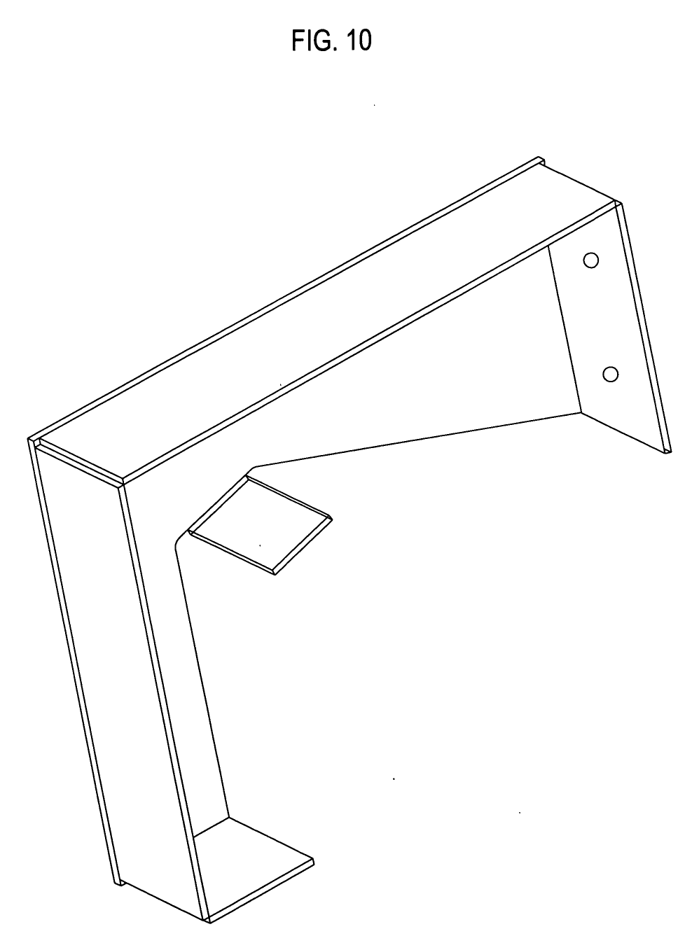

FIG. 10 illustrates a stamped and formed support bracket for the housing and LED/reflector assembly. Such brackets are easily fabricated from aluminum sheets using familiar sheet metal dies and presses.

1. What is claimed is a lighting fixture adapted to illuminate a panel, comprising:
a. a lamp housing with support brackets and splices,
b. a reflector affixed to the housing, providing a planar surface oblique to the fascia aiming the light at the center of the panel, having a plurality of surfaces to direct the light to the panel, and providing heat sink properties for the LEDs,
c. LED devices mounted within the reflector,
d. LED sources having a wide viewing angle to provide even illumination and monochromatic light of a wavelength closely matching the color of the fascia panel,
e. LED sources being conformable coated to allow for exterior service,
f and modular assemblies based on the LED spacing, with weatherproof connectors and a plurality of power sources.

2. The housing, as set forth in claim #1, a preferable embodiment is a flat aluminum composite panel, pre-finished and scored to fold in the field to the configuration noted in the drawings, allowing a quantity of panels to ship flat, saving freight, and being folded into shape on site to provide continuous lengths of cove or hood housing.

3. The preferably embodiment, as set forth in claim #1, is 144″ lengths, but other sizes and configurations can be provided and the flat aluminum composite panel material is easily cut in the field to provide custom lengths.

4. Support brackets, as set forth in claim #1, which also serve as a joining splice strip between sections of the housing and provide a fixed angle for mounting the reflector, are included to attach to the panel and provide for windload and snowload requirements of various applications.

5. LED devices, as set forth in claim #1, are mounted in the housing using heat conductive tape and aluminum rivets to provide maximum heat dissipation and mechanical security.

6. LED devices, as set forth in claim #1, being semiconductor lighting devices generally generating a wide beam pattern of 150 degrees to 180 degrees, positioned at an angle to project the center of this beam angle to the center of the fascia below, with spacing of these LEDs such that the beam angle overlap eliminates any scalloping or cone wash effect from the point sources

7. One embodiment of the LED devices, set forth in claim #1, would be a 180 degree low flux LED system placed on 3¾″ centers; another embodiment would be a 150 degree high flux LED system placed on 6″ centers; however, other flux level and beam angles could be used requiring differing center spacing.

8. LED devices, as set forth in claim #1, emitting a narrow wavelength associated with a monochromatic light with a preferred embodiment would be 465 to 470 nanometer to match a metallic blue, but other colors could be used to match other colors of fascia panels.

9. LED devices, as set forth in claim #1, being conformable coated to prevent the entry of water and allow for the light fixture to be used in outdoor applications.

10. A reflector, as set forth in claim #1, providing an angled surface for mounting the LEDs pointing the center of the emitted light beam at the center of the panel below.

11. A reflector, as set forth in claim #1, formed with angles to provide for various reflecting surfaces to direct the light in an even distribution over the panel below, characterized with a trough shaped reflector having a substantially reverse parabolic section positioned in front of the LED; a reflector positioned behind the LED having a planar surface to direct light towards the front section; and a reflector with perpendicular mounting flange for attachment coincidental with the beam angle directed to the top of the visible area of the panel below resulting in the effect of said reflector to restrict the emitted beam angle perpendicular to the panel to a 50 degree beam, and direct the substantial portion of the light to the panel below.

12. The reflector material, as set forth in claim #1, is preferably a specular aluminum, providing conductivity favorable to dissipating the heat generated by the LED devices; and, the preferred embodiment is specular aluminum in 0.020 thickness such as provided by Alanod 320/G2, Miro 6850 or Miro 5013; with alternate materials, such as ACA Textured Brite 973TB or SuperUltraBrite 4250E, used as required depending on the brightness of the LEDs and the gloss of the panel illuminated.

13. The assemblies, as set forth in claim #1, are provided in modular sections, preferably 93.75″, with 60″, 30″ and 15″ offered as well to allow for varying lengths and for multiples of the LED spacing as desirable, with ½ space on each end to allow for continuous match up, which can be overlapped for minor length adjustments, with end caps provided to allow for adjustment up to 12″, and the final end modules can be cut in the field to fabricate any length required.

14. Each assembly module, as set forth in claim #1, is provided with weatherproof connectors, male and female, to attach from one module to the next and provide a continuous electrical path, as well as accept a connector to power supplies, such connectors being a preferred embodiment of JST brand WVLR and WVLP or equivalent, meeting UL1471.

15. Power supplies, as set forth in claim #1, are provided as UL listed as Class 2, 12 VDC regulated and constant current supply for the LEDs used; such power supplies mounted in the housing, behind the reflector for easy access and maintenance, or behind the fascia panel for alternate access, and are provided with the same weatherproof connector as the modules for easy installation and modularity.
